(19) United States
(12) Patent Application Publication
(10) Pub. No.: US 2008/0203775 A1
(43) Pub. Date: Aug. 28, 2008

(54) Stairlifts

(76) Inventors: Adian Barclay Caroen, East Sussex (GB); Michael James Webster, London (GB)

Correspondence Address: NIXON & VANDERHYE, PC, 901 NORTH GLEBE ROAD, 11TH FLOOR, ARLINGTON, VA, 22203, US

(21) Appl. No.: 11/667,726

(22) PCT Filed: Nov. 15, 2005
(86) PCT No.: PCT/GB05/04365

§ 371 Date: Nov. 2, 2007

(30) Foreign Application Priority Data
Nov. 15, 2004 (GB) 0425238.3

(51) Int. Cl. A61G 5/06

(52) U.S. Cl. 297/30; 297/35

(57) ABSTRACT

The invention provides a stairlift chair in which the seat and armrests move simultaneously when the chair is folded. In a preferred embodiment the footrest also folds, with the armrests and seat, when the chair is folded.

### FIELD OF THE INVENTION

This invention relates to stairlifts and, in particular, to a stairlift chair assembly.

### BACKGROUND TO THE INVENTION

A typical stairlift chair comprises a seat surface, a pair of armrests, and a footrest. These various components are arranged in spaced horizontal planes when the stair lift is in use. However, when the stair lift is not is use, it is desirable that these components be folded into substantially vertical planes so as to minimise the width of the installation and reduce interference with the normal use of the stairway in which the stairlift is fitted.

In the past stairlift chairs have been provided in which the individual components have been foldable but, generally, separately. Some chairs have a footrest and seat which are foldable simultaneously, and some have a footrest which folds with the armrests.

A particular drawback arises from the inability to fold the armrests simultaneously. If there is a wish to fold the stairlift at the upper end of the staircase, the person effecting the folding must lean out over the stair to fold the armrest on the down-stair side of the chair. Given that such a person may well be a stairlift user, and have limited physical capacity, leaning out in such a manner is undesirable and exposes the person to a greater risk of falling down the stairway.

It is an object of the invention to provide a stairlift chair which will go at least some way in addressing the aforementioned problem; or which will at least provide a novel and useful choice.

### SUMMARY OF THE INVENTION

Accordingly, in a first aspect the invention provides a stairlift chair, having a seat, a pair of armrests and a footrest,

said chair being characterised in that linking means are provided between said armrests and said seat to enable simultaneous folding of said seat and said armrests.

Preferably said chair is further characterised in that footrest folding means are provided, said footrest folding means being responsive to said seat and armrests being displaced into a folded position, to displace said footrest into a folded position.

Preferably said linking means are dis-engageable to permit one or both of said armrests to fold independently of said seat.

Preferably said footrest folding means includes an electric motor operable to displace said footrest into a folded position, and a switch actuable by folding movement of said seat, to operate said electric motor.

Alternatively said footrest folding means includes a mechanical linkage connecting said seat section and/or armrests to said footrest.

In a second aspect, the invention provides a stairlift installation including the chair as set forth above.

Many variations in the way the present invention can be performed will present themselves to those skilled in the art. The description which follows is intended as an illustration only of one means of performing the invention and the lack of description of variants or equivalents should not be regarded as limiting. Wherever possible, a description of a specific element should be deemed to include any and all equivalents thereof whether in existence now or in the future. The scope of the invention should be limited by the appended claims alone.

### BRIEF DESCRIPTION OF THE DRAWINGS

One preferred form of the invention will now be described with reference to the accompanying drawings in which:

FIGS. 1A to 1C: show isometric views of a stairlift chair according to the invention being displaced between operative and fully folded configurations; and

FIGS. 2A to 2C: show respective side views of the chair configurations shown in FIGS. 1A to 1C.

### DETAILED DESCRIPTION OF WORKING EMBODIMENT

This invention provides a novel form of chair 5 for incorporation into a stairlift. In the conventional manner the chair 5 is mounted on a stairlift carriage (not shown) which carriage is, in turn, mounted for travel along a stairlift rail (not shown).

As with all conventional stairlift chairs, the chair 5 includes a seat 6, a pair of armrests 7a and 7b, a backrest 8 and a footrest 9. The characterising feature of the chair 5 is that it includes linking means which interconnect the seat 6 and the armrests 7a and 7b to ensure that, when the seat is folded up to reduce the width of the stair lift installation when not in use, the armrests also fold. In a preferred embodiment of the invention, the footrest 9 also folds in response to the seat being displaced towards the folded configuration.

As can be seen from the drawings the arms 7a and 7b are pivoted at their rear edges 10 to the backrest 8. Similarly, the rear edge 11 of the seat 6 is fixed to an L-shaped bracket 12 which pivots out of the plane of the backrest. In the particular form of chair 5 shown, the linking means preferably comprises a pair of link bars 15 which interconnect the seat 6 and armrests 7 and are pivoted to both at positions forward of the edges 10 and 11 respectively.

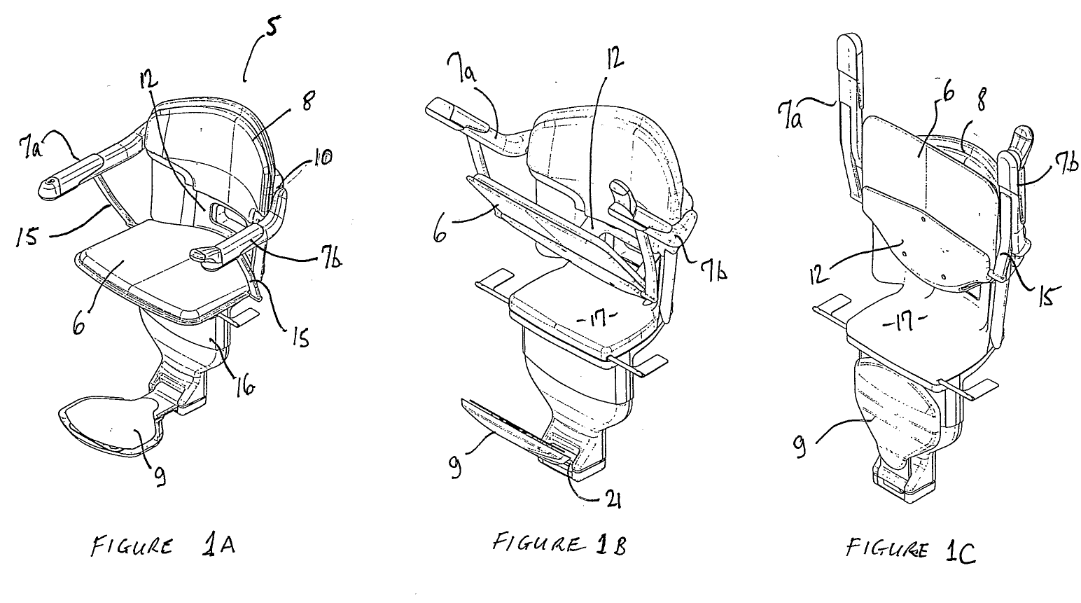

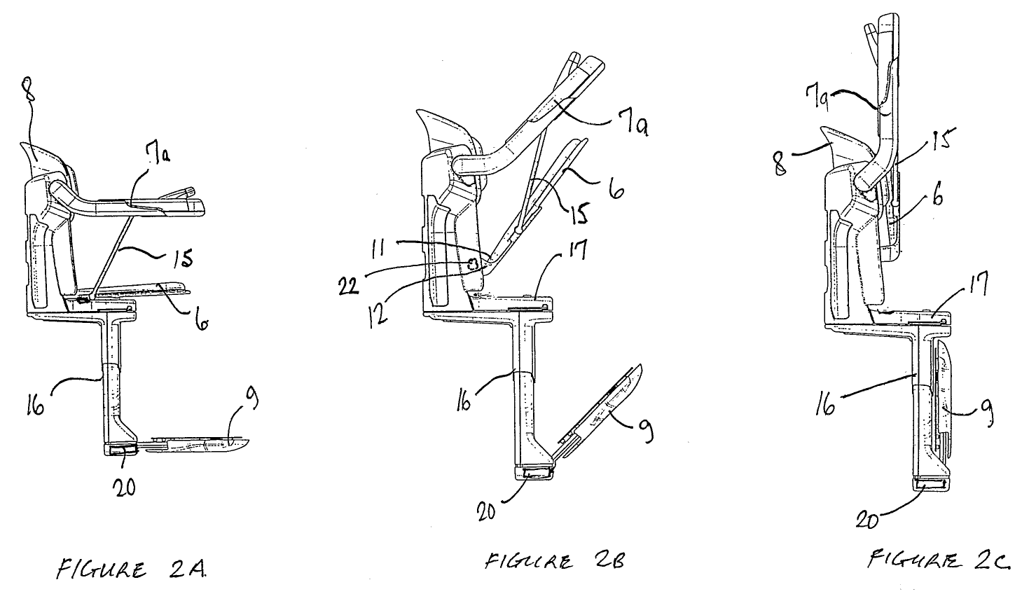

It will also be appreciated that, when the chair 5 is in the operative configuration shown in FIGS. 1A and 2A, the seat section 6 rests on, and is stabilized by, a horizontal surface 17 of the chair interface 16. In this position, the positions of the armrests 7a and 7b are preferably determined by mechanical stops (not shown). This means that one or both of the link bars 15 can be disconnected, and the corresponding armrest(s) pivoted up, to allow sideways entry on to, and exit off, the seat 6. This is a requirement if the stairlift is to be used by wheelchair-bound persons.

When the chair is to be folded into the configuration shown in FIGS. 1C and 2C, in which the seat section 6 lies substantially against the backrest 8, either the seat 6 or one of the armrests 7 is grasped manually and folded upwardly. By virtue of the link bars 15, that component which is not manually displaced is also brought into the folded configuration. Importantly, folding of one of the armrests automatically effects folding of the other armrest.

In the embodiment shown in the drawings, footrest folding means are provided to ensure the footrest 9 also folds with the seat section 6 and armrests 7. This folding is preferably effected electrically but may also be effected using some form of mechanical linkage.

To fold the footrest 9 electrically, a motor/gearbox unit 20 is preferably provided in the base of the chair interface 16 to act directly on the pivot 21 between the footrest and the interface. This motor/gear box operates in response to a switch 22 which is actuated during folding of the seat 6 relative to the interface.

The switch 22 could be mounted in any convenient position but, as shown, is preferably mounted on the hinge axis between the seat 6 and the backrest 8, and activates the motor 20 when the seat is at an angle of about 45° to the interface surface 17.

As stated above, the footrest could be pivoted by a mechanical arrangement. Such an arrangement might, for example, comprise a combination of lever arms and Bowden cable.

It will thus be appreciated that the present invention, at least in the case of the working embodiment described herein provides a chair for a stairlift which has the following advantages:
a) Displacement of one of the projecting components (seat or armrests) into a folded position automatically ensures that the other projecting components are also folded. This increases the likelihood that the chair will be properly folded when not in use, thus minimising the inconvenience when able-bodied persons use the stairs to which the stairlift is fitted.
The act of folding one of the armrests causes the other armrest to fold. This avoids the need to lean out over an open staircase, at the top of the stairs, to effect folding, and substantially reduces the danger to which a user is exposed.
c) As the footrest also folds with the seat and armrests, no bending or stooping is required to separately fold the footrest.

1. A stairlift chair, having a seat, a pair of armrests and a footrest,
said chair being characterised in that linking means are provided between said armrests and said seat to enable simultaneous folding of said seat and said armrests.

2. A chair as claimed in claim 1 further characterised in that footrest folding means are provided, said footrest folding means being responsive to said seat being displaced into a folded position to displace said footrest into a folded position.

3. A chair as claimed in claim 2 wherein said footrest folding means includes an electric motor operable to displace said footrest into a folded position, and a switch actuable by folding movement of said seat and/or armrests, to operate said electric motor.

4. A chair as claimed in claim 2 wherein said footrest folding means includes a mechanical linkage connecting said seat and/or armrests to said footrest.

5. A chair as claimed in claim 1, wherein said linking means are dis-engageable to permit one or both of said armrests to fold independently of said seat.

6. (canceled)

7. A stairlift installation including the chair as claimed in claim 1.
